(19) United States
(12) Patent Application Publication
(10) Pub. No.: US 2023/0335868 A1
(43) Pub. Date: Oct. 19, 2023

(54) CIRCULAR LITHIUM BATTERY AND METHOD FOR PRODUCING THE SAME

(71) Applicant: PHYLION BATTERY CO., LTD., Suzhou (CN)

(72) Inventors: Zhengwei WANG, Suzhou (CN); Kun DING, Suzhou (CN)

(21) Appl. No.: 18/028,735

(22) PCT Filed: Sep. 22, 2021
(86) PCT No.: PCT/CN2021/119726

§ 371 Date: Mar. 27, 2023

(30) Foreign Application Priority Data
Sep. 30, 2020 (CN) 202011063352.3

(51) Int. Cl. H01M 50/533; H01M 10/0525; H01M 50/107; H01M 50/152; H01M 50/119; H01M 50/538; H01M 10/04; H01M 50/184; H01M 50/186; H01M 50/342; H01M 50/655; H01M 50/536; H01M 10/0587

(52) U.S. Cl. CPC H01M 50/533; H01M 10/0525; H01M 50/107; H01M 50/152; H01M 50/119; H01M 50/538; H01M 10/0431; H01M 50/184; H01M 50/186; H01M 50/3425; H01M 50/655; H01M 50/536; H01M 10/049; H01M 10/0587

(57) ABSTRACT

A cylindrical lithium battery and a producing method thereof are disclosed. The lithium battery includes a shell, a battery cell, a cathode battery cover-plate assembly and an anode battery cover-plate assembly. A cathode foil and an anode foil are separated by a separator and wind into a cylindrical battery cell. The cathode is of a multi-tab structure and the anode is of a full-tab structure. A sealing body is fixed on the cathode battery cover plate in a surrounding manner, and a safety valve is provided at the middle of the cathode battery cover plate. The anode battery cover-plate assembly includes a current collector, an anode battery cover plate and a current collector support. The current collector body is fixedly connected to the upper portion of the current collector support and is electrically connected to the anode battery cover plate via a current collector connecting portion.

### FIELD OF THE INVENTION

The present invention relates to a lithium-ion battery, in particular to a cylindrical lithium-ion battery and a method for producing the same, and more specifically to a cylindrical lithium battery applicable as a power battery.

### DESCRIPTION OF THE RELATED ART

With constant development in the industry of new energy sources, lithium-ion batteries have been applied in various electric vehicles. Because of the large discharge current of the power battery, the internal pressure increases due to the gas generated by the internal electrolyte during use, which is more likely to cause potential safety hazards. In order to reduce the heat generated during use of the battery, a full-tab lead-out approach has emerged for lead-out of the electrode, in which the cathode foil and the anode foil extend from the upper and lower ends of the battery cell respectively to form the full-tab, which is flattened and then welded on the current collector sheet to reduce the resistance and heat generation at the lead-out position. However, such a structure makes it difficult to inject liquid into the battery, which affects the liquid injection and formation operation of the battery.

China patent application CN110600795A discloses a cylindrical lithium-ion battery including a battery cell, a shell and a current collector tray, in which the height of the battery cell is smaller than that of the shell, the shell is of a cylindrical shape, the battery core is positioned inside the shell, two ends of the battery cell are provided with tabs, one end with a cathode tab, and the other end with an anode tab, and the end face of the tab is an annular stepped surface. A ring-shaped groove is provided on the current collector tray of the cathode and anode, and the groove is a welding area. The annular stepped surface on the tab is attached to the ring-shaped groove on the current collector tray for welding, and a predefined distance is left at the beginning and end of the welding trace during welding. According to the technical solution described above, lead-out of the electrode is realized through the current collector tray. However, the cathode current collector tray will affect liquid injection and formation of the battery, and although the annular groove arranged on the current collector tray can fit the shape of the tab of the annular stepped surface, it causes reduced welding area between the inner ring and the outer ring, which affects the lead-out current in part of the winding layer. Meanwhile, there is a large space between the current collector tray and the shell, which is susceptible to problems such as peel-off of the welding in case of shocking and squeezing, thereby affecting normal use of the battery. Besides, the safety problem caused by gas generated inside the battery is not taken into account in this solution.

China patent application CN109088037A discloses a welding structure of a current collector tray for a cylindrical battery. An aluminum pole piece includes a current collector tray portion and a connecting portion, a copper pole piece and a cathode cover plate are sequentially arranged above and fixed to the connecting portion from top to bottom, and a tray sleeve made of an insulating material is fitted around the periphery of the current collector tray portion and fixed to the current collector tray portion. This structure ensures stability of the current collector tray and increases the welding diameter of the current collector tray by providing the tray sleeve. If this structure is applied to the anode battery cover plate, the following problems exist: the tray sleeve and the current collector tray are positioned relative to each other by a plurality of positioning columns, which leads to separation between the plurality of fan-shaped areas of the current collector tray and the battery cell by the tray sleeve, and the current collector tray can only be welded with the tab via several welding slots, which increases the radial welding range, but reduces the circumferential welding area and affects the current lead-out effect. Meanwhile, the tray sleeve is sleeved over the current collector tray also increases the difficulty in welding.

China patent application CN106025112A discloses a cathode lithium battery cover plate including a cover plate body, a cathode screw seat, a cathode pole, rivets, a cathode connecting part and an explosion-relief valve, in which the cover plate body is of a circular structure, the cathode screw seat is provided in the middle of the front face of the cover plate body, and the cathode pole is provided in the middle of the cathode screw seat and is 6 mm higher than the cathode screw seat. The rivets are provided on the cathode screw seat and positioned at the left and right ends of the cathode pole respectively; the positive connecting part is fixedly connected to the back face of the cover plate body via the rivets; the explosion-relief valve is provided on the upper part of the cathode screw seat; and the end portions of the cathode connecting part are of a semicircular structure. According to this technical solution, the cathode pole is provided at the center of the cover plate, with the explosion-relief valves and the liquid injection hole provided respectively on two sides, and the cathode pole piece of the battery is connected via the connecting part. Although the safety performance of the battery is improved by using the explosion-relief valve, the overall structure has the following defects: (1) the explosion-relief valve and the liquid injection hole are arranged respectively on two sides of the cover plate, and multiple sealing points exist on the cover plate, so the fabrication and installation process is complicated, and (2) the pole piece group in the cylindrical battery is of a vertical winding structure, the center of winding is a through hole, and the liquid injection hole is positioned at the lateral side of the cover plate, which will affect the liquid injection speed.

Therefore, it is a problem to be solved in design of the structure of a lithium battery to take into account the liquid injection and formation, discharge capability and safety protection of a cylindrical lithium battery.

### SUMMARY OF THE INVENTION

An objective of the present invention is to provide a cylindrical lithium battery. By means of the structural design, the invention ensures the discharge capability of the lithium battery while improving its liquid injection and formation efficiency as well as safety performance. Another objective of the present invention to provide a method for producing the cylindrical lithium battery.

For the above purpose, the present invention adopts the following technical solutions.

A cylindrical lithium battery includes a shell, a battery cell, a cathode battery cover-plate assembly and an anode battery cover-plate assembly. The shell is a metal pipe, and the battery cell is positioned inside the shell. The battery cell includes a cathode foil, an anode foil and a separator, the cathode foil and the anode foil are separated by the separator and wound into a cylinder.

A plurality of cathode tabs are provided at interval on an upper end of the cathode foil. A lower end of the battery cell is arranged in an unaligned manner, wherein at the lower end of the battery cell, the cathode foil, the separator and the anode foil are arranged in ascending order in length, and an extension portion of the anode foil is covered by the lower end of the battery cell by pressing, and is separated from the cathode foil by the separator.

The cathode battery cover-plate assembly includes a disc-shaped cathode battery cover plate and a sealing body. The sealing body is configured to an annular structure, and the sealing body is arranged along the periphery of the cathode battery cover plate and is fixedly connected to the cathode battery cover plate. The cathode battery cover plate is provided with a safety valve thereon, and the cathode tabs are electrically connected to the cathode battery cover plate.

The anode battery cover-plate assembly includes a current collector, an anode battery cover plate, and a current collector support. The current collector support is an annular part, and the annular part has a notch at one side thereof. The current collector has a current collector body and a current collector connecting portion. The current collector body is fixedly connected to an upper portion of the current collector support, the current collector connecting portion is located at the side of the annular part with the notch, and the current collector connecting portion is fixedly connected to the cover plate. The current collector connecting portion has a flexible bent structure, enabling the cover plate to be positioned below the current collector support in an installation state, the current collector body is electrically connected to the extension portion of the anode foil.

In the technical solution described above, different from the solution in prior art in which the same structure is adopted for the cathode lead-out structure and the anode lead-out structure, the cathode lead-out structure is configured as a multi-tab structure, and the anode lead-out structure is configured as a full-tab structure. Therefore, the cathode lead-out structure will not affect liquid injection and formation of the battery, and the full-tab lead-out structure of the anode is utilized to improve the overcurrent capability of the battery and reduce the heat dissipation requirement of the battery. Also, as the current collector structure is utilized for the anode and multi-tab connection is adopted for the cathode, the anode assembly can be fixed by welding and installed to the shell, and the cathode battery cover plate is installed at last, which facilitates assembly.

In the technical solution described above, a through hole is provided at the center of the cathode battery cover plate and the through hole is used as a liquid injection hole. The periphery of the through hole has a stepped structure, the through hole and the stepped structure at the periphery of the through hole together constitute an installation position for the safety valve. While the battery is in a factory state, the safety valve is fixed at the installation position for the safety valve. The cathode battery cover plate is provided with a periphery, the thickness of the periphery is less than the thickness of the cathode battery cover plate, so that a sealing body fixation portion is formed. The sealing body encloses the sealing body fixation portion, and one end of the shell covers the sealing body through mechanical rolling, so that the shell is hermetically fixed to the cathode battery cover plate.

In a further technical solution, the safety valve includes a safety valve body and a safety valve cap. The stepped structure at the periphery of the through hole has a first step and a second step shallower than the first step, and the through hole, the first step and the second step are arranged sequentially from inside to outside. The periphery of the safety valve body is fixed on the first step and the safety valve cap is fixed on the second step.

In the technical solution described above, various structures suitable for installation in the through hole can be used for the safety valve body, such as the a film bursting structure, a needle punching structure, or the like.

In the technical solution described above, the current collector body is substantially disc-shaped, the current collector body has a bending portion that is bent downward at the periphery of the current collector body. The annular part is a plastic part, and the annular part encloses the bending portion of the current collector body by injection molding, so that the current collector body and the annular part form an integral structure. The current collector body is fixedly connected to the upper portion of the current collector support. As such, the current collector support will not occlude the current collector body or the battery cell, so that a large area for welding exists between the current collector body and the extension portion of the anode of the battery cell, thereby ensuring uniformity in the current and the overcurrent capability of the electrode. Meanwhile, the current collector support also provides a positioning reference for the installation of the cover plate, which facilitates installation of the anode cover-plate assembly.

In the technical solution described above, the current collector body has several reinforcement grooves that are radially arranged thereon, and the current collector body has a sector portion between adjacent reinforcement grooves, the sector portion constitutes an anode welding and connecting portion.

In a preferred technical solution, four reinforcement grooves are arranged evenly at an interval of angle 90° on the current collector body. The notch is provided between two of the reinforcement grooves, and the notch has a radian between 60° and 90° on the circumference of the annular part.

In the technical solution described above, an extension length of the anode foil beyond the battery cell after being pressed make adjacent layers of the anode foil overlap each other, forming an anode lead-out portion

In a preferred technical solution, the shell is a stainless steel pipe or stainless iron pipe.

To achieve another objective of the present invention, the present invention provides a method for producing the cylindrical lithium battery described above, including the steps of:
(1) stacking the cathode foil and the anode foil and separating the cathode foil and the anode foil with the separator, then winding them into a cylinder;
(2) shaping and ultrasonically welding the cathode tabs, and flattening the extension portion of the anode foil, to form a battery cell;
(3) laser welding the anode battery cover plate with the current collector connecting portion to obtain the anode battery cover-plate assembly;
(4) multiple spot welding the extension portion of the anode foil with the current collector body, making the anode battery cover-plate assembly assemble to the battery cell, to obtain an anode battery cover plate-battery cell assembly;
(5) placing the anode battery cover plate-battery cell assembly into the shell, and completely sealing the periphery of the anode battery cover plate to the shell by welding;
(6) welding the cathode tabs to the back side of the cathode battery cover plate, then installing the cathode battery cover plate in the shell, and fixing and sealing the shell and the cathode battery cover plate through mechanical rolling;
(7) extracting air from the battery cell through the through hole on the cathode battery cover plate and injecting electrolyte to the battery cell; and
(8) fixing the safety valve onto the through hole by welding, to accomplish assembly of the lithium battery.

In a further technical solution, the safety valve cap is installed after welding and fixing of the safety valve, and then the whole battery is enveloped with an outer insulation film.

By means of the technical solutions described above, the present invention has the following advantages as compared with the prior art:
1. The present invention overcomes the conventional conception of using the same structure for the cathode lead-out structure and the anode lead-out structure by using a multi-tab structure for the cathode lead-out structure and a full-tab structure for the anode lead-out structure, and thus ensures the overcurrent capability of the battery while facilitating liquid injection and formation of the battery.
2. The present invention changes the conventional conception in the prior art that the pole is provided at the center of the battery cover plate by realizing lead-out of the electrode at the central annular portion of the disk-shaped cover plate, so that the liquid injection hole and the safety valve can be provided at the center to effectively increase the liquid injection speed. As the liquid injection hole and the safety valve are provided at the same position, sealing of the liquid injection hole can be accomplished at the same time as welding of the safety valve, which omits the sealing process of the liquid injection hole.
3. According to the present invention, the sealing body and the cathode battery cover plate are formed as an integral structure through pouring, which facilitates subsequent fixing of the cathode battery cover plate to the battery shell through mechanical rolling, thereby improving the yield.
4. According to the present invention, a current collector support fixedly connected to the current collector is provided, so that the reliability in installation of the current collector is ensured, and a larger welding area is obtained, thereby leading to greater overcurrent capability of the battery. The current collector support may be a plastic part, and the current collector support can enclose and be connected to the current collector body during molding by using an injection molding process, so that the two parts constitute an integral structure, thereby facilitating installation.
5. According to the present invention, during installation, first the anode battery cover-plate assembly is connected to the battery cell, and then fitted in the shell, subsequently the anode battery cover plate is welded to the shell, and the cathode tabs are welded to the cathode battery cover-plate assembly, finally the cathode battery cover plate is fixed to the shell through mechanical rolling, which enables convenient and reliable installation.

### BRIEF DESCRIPTION OF THE DRAWINGS

FIG. 1 is a schematic structural sectional view of an embodiment of the present invention;

FIG. 2 is a top view of FIG. 1;

FIG. 3 is a schematic exploded view of FIG. 1;

FIG. 4 is a schematic structural view of the battery cell;

FIG. 5 is a schematic enlarged view of part B in FIG. 4;

FIG. 6 is a top view of the cathode cover-plate assembly in an embodiment;

FIG. 7 is a sectional view along line A-A of FIG. 6;

FIG. 8 is a schematic exploded view of FIG. 7;

FIG. 9 is a schematic unfolded view of the anode battery cover-plate assembly of an embodiment;

FIG. 10 is a sectional view along the line C-C of FIG. 9; and

FIG. 11 is a schematic enlarged view of part D in FIG. 10.

### REFERENCE NUMBERS IN THE DRAWINGS

1 safety valve cap; 2 safety valve body; 3 cathode battery cover plate; 4 sealing body; 5 insulating spacer; 6 cathode tab; 7 shell; 8 battery cell; 9 current collector; 10 anode battery cover plate; 11 cathode foil; 12 anode foil; 13 separator; 14 through hole; 15 first step; 16 second step; 17 sealing body fixation portion; 18 current collector support; 19 notch; 20 current collector body; 21 current collector connecting portion; 22 bent portion; 23 reinforcement groove; 24 anode welding and connecting portion

### DETAILED DESCRIPTION OF THE PREFERRED EMBODIMENTS

The present invention will be further described with reference to the accompanying drawings and embodiments:

### Embodiment 1

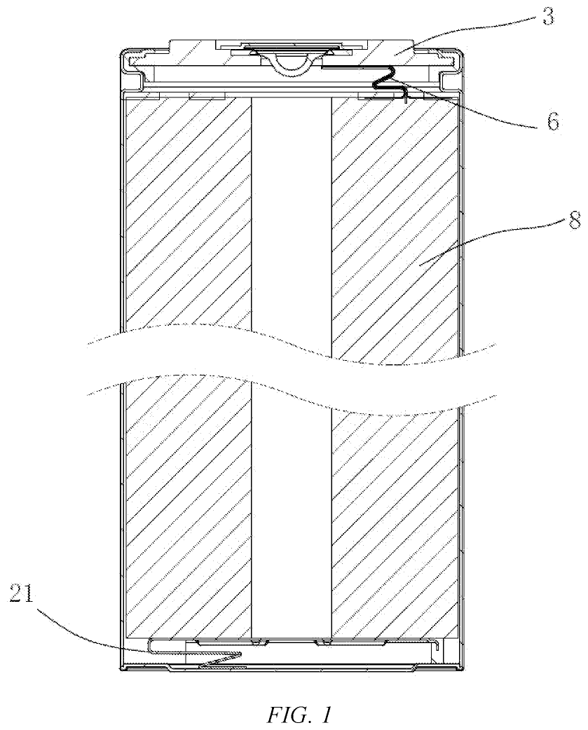

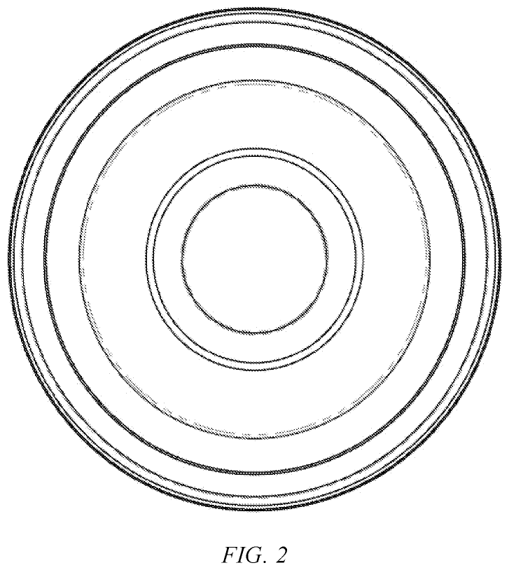

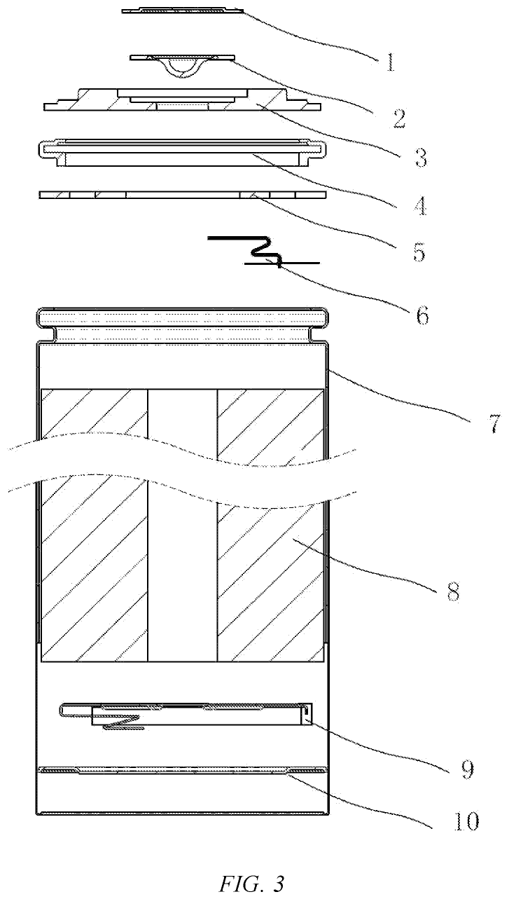

Referring to FIG. 1 to FIG. 3, a cylindrical lithium battery includes a shell 7, a battery cell 8, a cathode battery cover-plate assembly and an anode battery cover-plate assembly. The shell 7 is a stainless steel pipe. The battery cell 8 is positioned inside the shell 7.

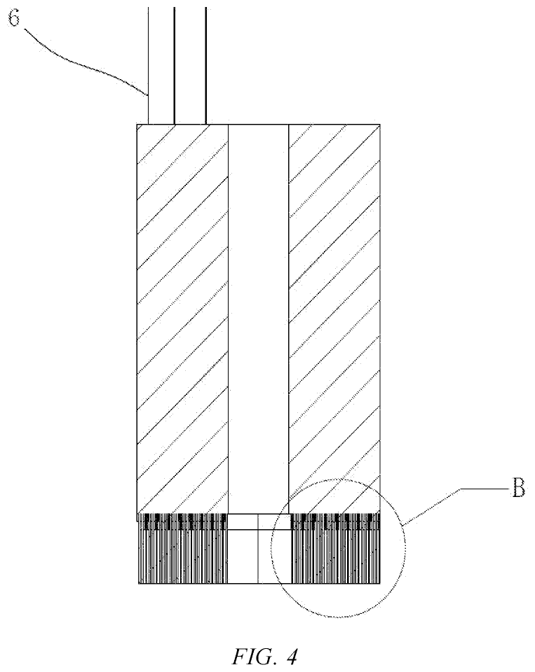

Referring to FIG. 4 and FIG. 5, the battery cell 8 includes a cathode foil 11, an anode foil 12 and a separator 13. The cathode foil 11 and the anode foil 12 are separated by the separator 13 and then wound into a cylinder. A plurality of cathode tabs 6 are provided at interval on the upper end of the cathode foil 11. An insulating spacer 5 is provided between the battery cell 8 and the cathode battery cover-plate assembly. The lower end of the battery cell is provided in an unaligned manner, and at the lower end of the battery cell, the cathode foil 11, the separator 13 and the anode foil 12 are arranged in ascending order in length. An extension portion of the anode foil 12 is covered by the lower end of the battery cell by pressing and flattening, and is separated from the cathode foil 11 by the separator 13.

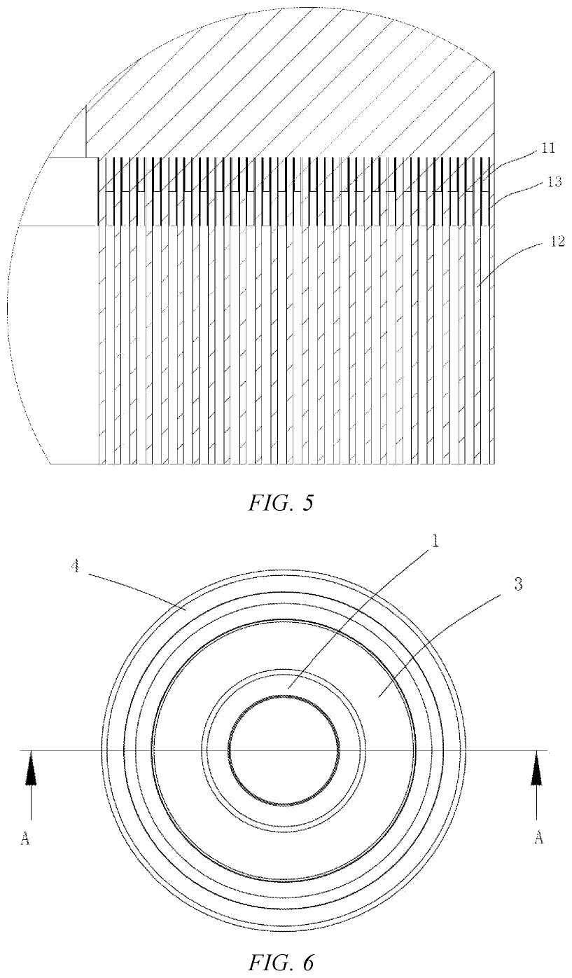

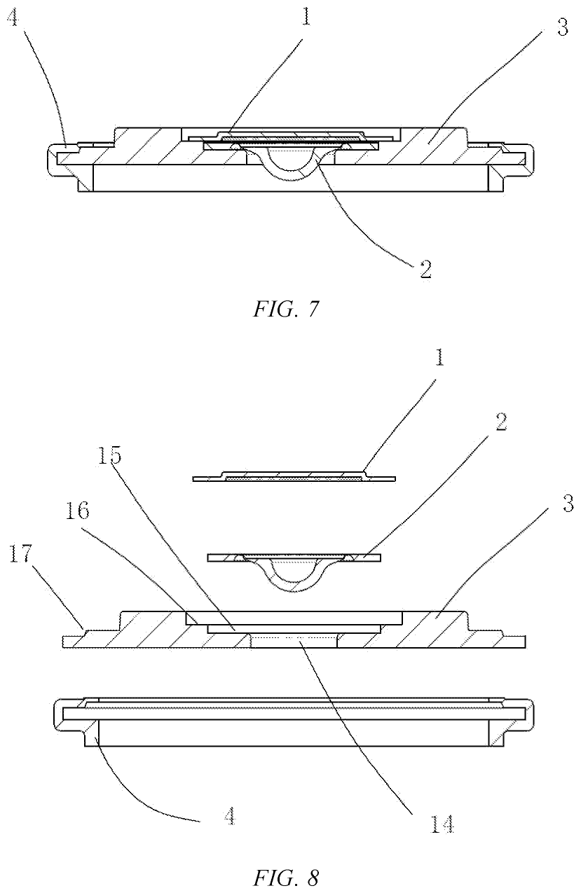

Referring to FIG. 6 to FIG. 8, the cathode battery cover-plate assembly includes a disc-shaped cathode battery cover plate 3 and a sealing body 4. The sealing body 4 is configured to an annular structure. The sealing body 4 is arranged along the periphery of the cathode battery cover plate 3 and is fixedly connected to the cathode battery cover plate 3. The cathode battery cover plate 3 is provided with a safety valve thereon. The cathode tabs 6 are electrically connected to the cathode battery cover plate 3.

A through hole 14 is provided at the center of the cathode battery cover plate 3. The periphery of the through hole 14 has a stepped structure which has a first step 15 and a second step 16 shallower than the first step 15. The safety valve body 2 is installed on the first step 15 and the safety valve cap 1 is installed on the second step 16.

The sealing body 4 is configured as an annular structure. To accommodate installation of the sealing body 4, the thickness of the periphery of the cathode battery cover plate 3 is smaller than the overall thickness of the cover plate so that a sealing body fixation portion 17 is formed. The sealing body 4 encloses the sealing body fixation portion 17 through pouring to increase the contact area, so that the integration of the sealing body with the battery cover plate is ensured. The sealing body fixation portion 17 is provided with a step thereon.

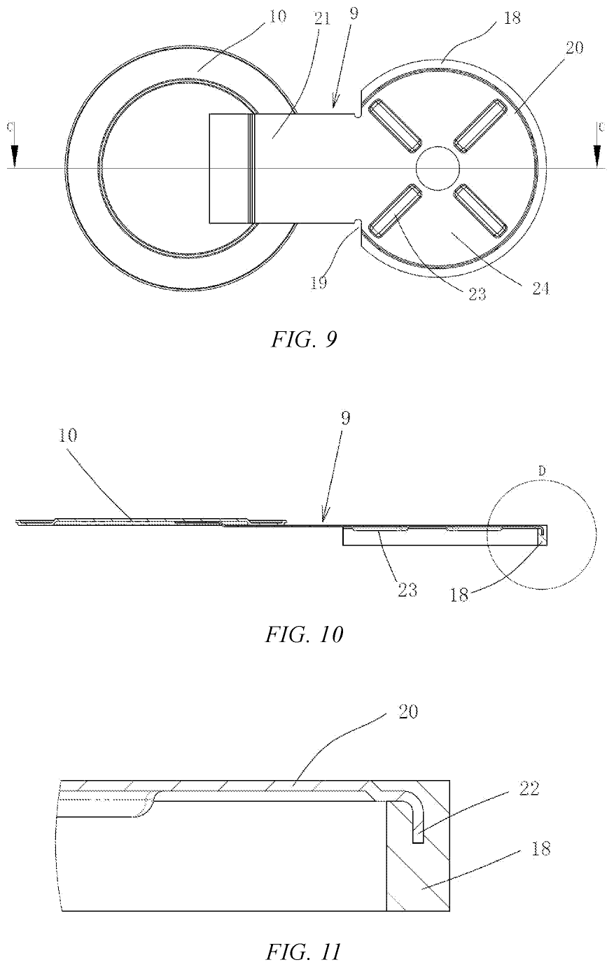

Referring to FIG. 9 to FIG. 11, The anode cover-plate assembly includes a current collector 9, a current collector support 18 and an anode battery cover plate 10. The current collector support 18 is an annular part having a notch 19 at one side thereof.

The current collector 9 may be a metal sheet made by stamping, and the current collector 9 has two functional parts: a current collector body 20 and a current collector connecting portion 21. The current collector body 20 is substantially disc-shaped. Referring to FIG. 10 and FIG. 11, the current collector body has a bent portion 22 that is bent ownward at the periphery of the current collector body. The annular current collector support 18 is injected molded to envelope the bending portion 22 so that the current collector body and the annular part form an integral structure. The current collector body 20 is positioned on the upper portion of the current collector support 18.

The current collector body 20 has four reinforcement grooves 23 that are radially arranged thereon. The reinforcement grooves 23 are arranged evenly at an interval of angle 90° on the current collector body. The current collector body has a sector portion between adjacent reinforcement grooves 23, and the sector portion forms an anode welding and connecting portion 24. The notch 19 is positioned between two of the reinforcement grooves. A circular through hole is provided at the center of the current collector body.

The current collector connecting portion 21 is positioned at the side of annular part with the notch, and the outer end of the current collector connecting portion is fixed to the anode battery cover plate 10 by welding. The current collector connecting portion 21 has a flexible bent structure, enabling the anode battery cover plate 10 to be positioned below the current collector support in an installed state.

The current collector body is fixedly connected to the upper portion of the current collector support. As such, the current collector support will not occlude the current collector body or the battery cell, so that a large area for welding exists between the current collector body and the extension portion of the anode of the battery cell, thereby ensuring uniformity in the current and the overcurrent capability of the electrode. Meanwhile, the current collector support also provides a positioning reference for the installation of the cover plate, which facilitates installation of the anode cover plate assembly.

The method for producing the cylindrical lithium battery in this embodiment includes the following steps:
(1) stacking the cathode foil and the anode foil and separating the cathode foil and the anode foil with the separator, then winding them into a cylinder;
(2) shaping and ultrasonically welding the cathode tabs, and flattening the extension portion of the anode foil, to form a battery cell;
(3) laser welding the anode battery cover plate with the current collector connecting portion to obtain the anode battery cover-plate assembly;
(4) multiple spot welding the extension portion of the anode foil with the current collector body, making the anode battery cover-plate assembly assemble to the battery cell, obtaining an anode battery cover plate-battery cell assembly;
(5) placing the anode battery cover plate-battery cell assembly into the shell, and completely sealing the periphery of the anode battery cover plate and the shell by welding;
(6) welding the cathode tabs to a back side of the cathode battery cover plate, then installing the cathode battery cover plate in the shell, and fixing and sealing the shell to the cathode battery cover plate through mechanical rolling;
(7) extracting air from the battery through the through hole on the cathode battery cover plate and injecting electrolyte; and
(8) fixing the safety valve onto the through hole by welding;
(9) installing the safety valve cap; and
(10) enveloping the whole battery with an outer insulating film, to accomplish assembly of the battery.

What is claimed is:

1. A cylindrical lithium battery comprising a shell, a battery cell, a cathode battery cover-plate assembly and an anode battery cover-plate assembly, the shell being a metal pipe, the battery cell being positioned inside the shell, and the battery cell comprising a cathode foil, an anode foil and a separator, the cathode foil and the anode foil being separated by the separator and winding into a cylinder, wherein
a plurality of cathode tabs are provided at interval on an upper end of the cathode foil; a lower end of the battery cell is arranged in an unaligned manner, wherein at the lower end of the battery cell, the cathode foil, the separator and the anode foil are arranged in ascending order in length, and an extension portion of the anode foil is covered by the lower end of the battery cell by pressing, and is separated from the cathode foil by the separator;
the cathode battery cover-plate assembly comprises a disc-shaped cathode battery cover plate and a sealing body, and the sealing body is configured to an annular structure, the sealing body is arranged along the periphery of the cathode battery cover plate and is fixedly connected to the cathode battery cover plate, the cathode battery cover plate is provided with a safety valve, and the cathode tabs are electrically connected to the cathode battery cover plate; and
the anode battery cover-plate assembly comprises a current collector, an anode battery cover plate, and a current collector support, the current collector support is an annular part having a notch at a side thereof, the current collector has a current collector body and a current collector connecting portion, the current collector body is fixedly connected to an upper portion of the current collector support, the current collector connecting portion is located at the side of the annular part with the notch, and the current collector connecting portion is fixedly connected to the cover plate, the current collector connecting portion has a flexible bent structure, enabling the cover plate to be positioned below the current collector support in an installation state, the current collector body is electrically connected to the extension portion of the anode foil.

2. The cylindrical lithium battery of claim 1, wherein a through hole is provided at the center of the cathode battery cover plate, a periphery of the through hole has a stepped structure, the through hole is used as a liquid injection hole, the through hole and the stepped structure at the periphery of the through hole together constitute an installation position for the safety valve, while the battery is in a factory state, the safety valve is fixed at the installation position for the safety valve, the cathode battery cover plate is provided with a periphery, a thickness of the periphery is less than a thickness of the cathode battery cover plate, to form a sealing body fixation portion, the sealing body encloses the sealing body fixation portion, and one end of the shell covers the sealing body through mechanical rolling, so that the shell is hermetically fixed to the cathode battery cover plate.

3. The cylindrical lithium battery of claim 2, wherein the safety valve comprises a safety valve body and a safety valve cap, the stepped structure at the periphery of the through hole has a first step and a second step shallower than the first step, wherein the through hole, the first step and the second step are arranged sequentially from inside to outside, and the periphery of the safety valve body is fixed to the first step and the safety valve cap is fixed to the second step.

4. The cylindrical lithium battery of claim 1, wherein the current collector body is substantially disc-shaped, the current collector body has a bending portion that is bent downward at the periphery of the current collector body, the annular part is a plastic part, and the annular part encloses the bending portion of the current collector body by injection molding, so that the current collector body and the annular part form an integral structure.

5. The cylindrical lithium battery of claim 4, wherein the current collector body has several reinforcement grooves that are radially arranged thereon, and the current collector body has a sector portion between adjacent reinforcement grooves, the sector portion constitutes an anode welding and connecting portion.

6. The cylindrical lithium battery of claim 5, wherein four reinforcement grooves are arranged evenly at an interval of angle 90° on the current collector body, the notch is provided between two of the reinforcement grooves, and the notch has a radian between 60° and 90° on the circumference of the annular part.

7. The cylindrical lithium battery of claim 1, wherein an extension length of the anode foil beyond the battery cell after being pressed make adjacent layers of anode foil overlap each other, forming an anode lead-out portion.

8. The cylindrical lithium battery of claim 1, wherein the shell is a stainless steel pipe or stainless iron pipe.

9. A method for producing a cylindrical lithium battery of claim 1, comprising steps of:
(1) stacking the cathode foil and the anode foil and separating the cathode foil and the anode foil with the separator, then winding them into a cylinder;
(2) shaping and ultrasonically welding the cathode tabs, and flattening the extension portion of the anode foil, to form a battery cell;
(3) laser welding the anode battery cover plate with the current collector connecting portion to obtain the anode battery cover-plate assembly;
(4) multiple spot welding the extension portion of the anode foil with the current collector body, making the anode battery cover-plate assembly assemble to the battery cell, obtaining an anode battery cover plate-battery cell assembly;
(5) placing the anode battery cover plate-battery cell assembly into the shell, and completely sealing the periphery of the anode battery cover plate and the shell by welding;
(6) welding the cathode tabs to a back side of the cathode battery cover plate, then installing the cathode battery cover plate in the shell, and fixing and sealing the shell to the cathode battery cover plate through mechanical rolling;
(7) extracting air from the battery through the through hole on the cathode battery cover plate and injecting electrolyte; and
(8) fixing the safety valve onto the through hole by welding, to accomplish assembly of the lithium battery.

10. The method for producing a cylindrical lithium battery of claim 9, wherein the safety valve cap is installed after welding and fixing of the safety valve, and then the whole battery is enveloped with an outer insulation film.
